(19) United States
(12) Patent Application Publication
(10) Pub. No.: US 2014/0259875 A1
(43) Pub. Date: Sep. 18, 2014

(54) SNARE TRAPPING SYSTEM AND METHOD

(71) Applicant: HAMMERED HOGS, LLC, Rayville, LA (US)

(72) Inventors: Ronald Lee Lewellyan, Columbia, LA (US); Eric James Broadway, Rayville, LA (US)

(73) Assignee: Hammered Hogs, LLC, Rayville, LA (US)

(21) Appl. No.: 13/835,894

(22) Filed: Mar. 15, 2013

(51) Int. Cl. A01M 23/34

(52) U.S. Cl. CPC A01M 23/34
USPC 43/87

(57) ABSTRACT

A snare trapping system including a trigger mechanism operatively connected to an anchor line. The trigger mechanism includes a base, a pivot arm pivotally connected to the base, a trip line extension operatively connected to the pivot arm, and a selective opening being a trigger aperture in a set position and a trigger slot in a tripped position. The trip line extension is operatively connected to a trip line. A main line is selectively connected to the trigger mechanism through a connection ring, a portion of which is disposed through the trigger aperture in the set position.

### BRIEF DESCRIPTION OF THE DRAWINGS

FIG. 1 is a front view of a snare trapping system.

FIG. 2 is a front view of a trigger mechanism of the snare trapping system.

FIG. 3 is a front view of the trigger mechanism in a set position.

FIG. 4 is a front view of the trigger mechanism in a tripped position.

FIG. 5 is a side perspective view of the trigger mechanism in the tripped position.

FIG. 6 is a perspective view of the snare trapping system in the set position near a trail.

### DETAILED DESCRIPTION OF THE PREFERRED EMBODIMENTS

With reference to FIG. 1, snare trapping system 10 may include trigger mechanism 12 operatively connected to anchor line 14. Anchor line 14 may be attached to an anchor. The anchor may be any object or assembly capable of securing system 10 to the ground, such as a stick, a bush, or a rebar driven into the ground. Another example of a suitable anchor to which anchor line 14 may be secured is the anchor assembly disclosed in U.S. Pat. No. 6,238,143.

With reference to FIG. 2, trigger mechanism 12 may include base 24, pivot arm 26, and trip line extension 28. Base 24 and pivot arm 26 may be formed of any durable material, such as metal or plastic. Trip line extension 28 may be formed of any durable material, such as metal or plastic. Pivot arm 26 may be pivotally connected to base 24.

With reference to FIGS. 2-5, base 24 may include slot 30 in its distal end. Pivot arm 26 may include arched finger 31 and recess 32 on its distal end and aperture 33 in its proximal end. In a set position (shown in FIGS. 2 and 3), slot 30 and arched finger 31 of pivot arm 26 may align to create trigger aperture 34 through recess 32 and a proximal end of slot 30. In a tripped position (shown in FIG. 4), pivot arm 26 may be rotationally displaced from base 24 such that arched finger 31 is not aligned with slot 30 such that an object retained through trigger aperture 34 in the set position may be released through slot 30 in the tripped position.

A portion of trip line extension 28 may be disposed through aperture 33 of pivot arm 26. In the set position, a portion of trip line extension 28 may be disposed in second slot 35 (shown in FIG. 4) in the proximal end of base 24. In the tripped position, trip line extension 28 may be disposed completely outside of second slot 35 in the proximal end of base 24.

Pivot arm 26 may include first member 36 and second member 38 (shown in FIG. 5) disposed on opposing sides of base 24. Trip line 40 may be operatively connected to trip line extension 28 on trigger mechanism 12. Trip line 40 may be formed of any string material, such as fishing line, nylon string, or steel wire. Trip line 40 is preferably formed of a thin string material.

With reference to FIG. 1, main line 42 may be selectively connected to trigger mechanism 12. Main line 42 may be formed of rope, parachute cord, or galvanized cable. In one embodiment, main line 42 may be connected to trigger mechanism 12 through connection ring 44 (shown in FIGS. 3 and 4), which may be disposed through trigger aperture 34 when trigger mechanism 12 is in the set position. Main line 42 may also be operatively connected to snare loop 46. In one embodiment, main line 42 and snare loop 46 are tied together. Alternatively, main line 42 and snare loop 46 may be integrally formed. In one embodiment, system 10 includes two snare loops 46. Snare loop 46 may be formed of any type of rope, such as nylon rope or galvanized cable.

As shown in FIG. 6, snare trapping system 10 may be employed near trail 50. A user may locate a spring pole near trail 50, such as spring pole 52. Alternatively, a user may cut a spring pole and place it near trail 50, such as by using a T-post and metal hose clamps. As understood by a skilled artisan, spring pole 52 should be strong enough to support the weight of a large animal. On the opposite side of trail 50 from spring pole 52, the user may tie anchor line 14 to any natural or man-made anchor existing or placed beside trail 50 that will securely hold system 10. With trigger mechanism 12 in the set position, the user may bend spring pole 52 down toward the anchor and attach main line 42 to spring pole 52 such that the end of spring pole 52 is approximately three feet above the ground. The user may then tie trip line 40 to support 54, such that trip line 40 extends horizontally across trail 50. Support 54 may be any upwardly extending member, such as a stick, a rebar, or a cane stalk. The user may then place snare loops 46 on the ground in the trail, with the two snare loops 46 on opposite sides of trip line 40. The user may cover snare loops 46 with brush, such as leaves, sticks, pine needles, or grass. The user may arrange snare loops 46 such that each has a diameter of about one foot, and such that snare loops 46 are about two to three inches apart.

When trip line 40 is actuated by an animal, trip line 40 pulls trip line extension 28 of trigger mechanism 12. Trip line extension 28 pulls pivot arm 26 such that it pivots from alignment with base 24 into the tripped position, releasing connection ring 44 and main line 42 as trigger aperture 34 opens. Because spring pole 52 was held down by main line 42, spring pole 52 then travels in an upward direction pulling main line 42 and snare loops 46 upwardly. Simultaneously, snare loops 46 may close around a portion of the animal, such as the animal's foot or hoof, trapping the animal. Snare loops 46 may lift an animal's foot or hoof above the ground. Alternatively, the animal may be trapped by lifting the entire animal above the ground. In yet another alternative, the animal may be trapped on the ground by snare loops 46 closing around a portion of its body. Snare trapping system 10 may be used to trap animals such as hogs.

While preferred embodiments of the present invention have been described, it is to be understood that the embodiments are illustrative only and that the scope of the invention is to be defined solely by the appended claims when accorded a full range of equivalents, many variations and modifications naturally occurring to those skilled in the art from a review hereof.

1. A snare trapping system comprising:
a trigger mechanism operatively connected to an anchor line, the trigger mechanism comprising a base, a pivot arm pivotally connected to the base, and a trip line extension operatively connected to the pivot arm, wherein the pivot arm comprises an arched finger and a recess in a distal end of the pivot arm and an aperture in a proximal end of the pivot arm dimensioned to receive a portion of the trip line extension therethrough, wherein the base comprises a first slot in a distal end of the base and a second slot in a proximal end of the base dimensioned to receive a portion of the trip line extension;
a trip line operatively connected to the trip line extension of the trigger mechanism;
a main line selectively connected to the trigger mechanism through a connection ring;
a snare loop operatively connected to the main line;
wherein in a set position the pivot arm is aligned with the base such that the arched finger of the pivot arm closes the first slot in the base forming a trigger aperture through the recess in the pivot arm and a proximal end of the first slot in the base, and wherein in the set position the trip line extension is disposed in the second slot of the base and a portion of the connection ring is disposed through the aperture; and
wherein in a tripped position the pivot arm is rotationally displaced from the base such that the arched finger of the pivot arm is out of alignment with the first slot in the base.

2. The snare trapping system of claim 1, wherein in the tripped position the trip line extension is not disposed in the second slot in the base.

3. The snare trapping system of claim 1, wherein the trigger mechanism further comprises a second pivot arm rotationally aligned with the pivot arm, wherein the base is pivotally disposed between the pivot arm and the second pivot arm.

4. The snare trapping system of claim 3, wherein the second pivot arm comprises a second arched finger and a second recess in a distal end of the second pivot arm and a second aperture in a proximal end of the second pivot arm dimensioned to receive a portion of the trip line extension therethrough.

5. The snare trapping system of claim 4, wherein in the set position the pivot arm and the second pivot arm are aligned with the base such that the arched finger of the pivot arm and the second arched finger of the second pivot arm closes the first slot in the base forming the trigger aperture.

6. The snare trapping system of claim 5, wherein in the tripped position the pivot arm and the second pivot arm are rotationally displaced from the base such that the arched finger of the pivot arm and the second arched finger of the second pivot arm are out of alignment with the first slot in the base.

7. A snare trapping system comprising:
a trigger mechanism operatively connected to an anchor line, the trigger mechanism comprising a base, a pivot arm pivotally connected to the base, a trip line extension operatively connected to the pivot arm, and a selective opening, wherein the selective opening is a trigger aperture in a set position and a trigger slot in a tripped position;
a trip line operatively connected to the trip line extension of the trigger mechanism;
a main line selectively connected to the trigger mechanism through a connection ring, wherein a portion of the connection ring is disposed through the trigger aperture in the set position; and
a snare loop operatively connected to the main line.

8. The snare trapping system of claim 7, wherein the selective opening is formed by a slot in a distal end of the base and an arched finger and a recess in a distal end of the pivot arm, wherein the recess of the pivot arm is aligned with a proximal end of the slot in the base and the arched finger of the pivot arm closes a distal end of the slot in the base to form the trigger aperture in the set position, and wherein the slot of the base forms the trigger slot in the tripped position.

9. The snare trapping system of claim 8, wherein a portion of the trip line extension is disposed through an aperture in a proximal end of the pivot arm, and wherein in a set position a portion of the trip line extension is disposed through a second slot in a proximal end of the base.

10. The snare trapping system of claim 8, wherein the trigger mechanism further comprises a second pivot arm rotationally aligned with the pivot arm, wherein the base is pivotally disposed between the pivot arm and the second pivot arm.

11. The snare trapping system of claim 10, wherein the second pivot arm comprises a second arched finger and a second recess in a distal end of the second pivot arm; and wherein the recess of the pivot arm and the second recess of the second pivot arm are aligned with the proximal end of the slot in the base, and the arched finger of the pivot arm and second arched finger of the second pivot arm close a distal end of the slot in the base to form the trigger aperture in the set position; and wherein the recess of the pivot arm and the second recess of the second pivot arm form the trigger slot in the tripped position.

12. The snare trapping system of claim 11, wherein a portion of the trip line extension is disposed through an aperture in a proximal end of the pivot arm and a second aperture in a proximal end of the second pivot arm, and wherein in the set position a portion of the trip line extension is disposed through a second slot in a proximal end of the base.

13. A method of trapping an animal, comprising the steps of:
(a) providing a snare trapping system comprising: a trigger mechanism operatively connected to an anchor line, the trigger mechanism comprising a base, a pivot arm pivotally connected to the base, a trip line extension operatively connected to the pivot arm, and a selective opening; a trip line operatively connected to the trip line extension of the trigger mechanism; a main line selectively connected to the trigger mechanism through a connection ring; and a snare loop operatively connected to the main line;
(b) placing the snare trapping system near a trail, wherein the snare trapping system is placed in a set position with the selective opening being a trigger aperture with a portion of the connection ring disposed therethrough, and wherein the trip line extends horizontally across the trail; and
(c) allowing the snare trapping system to trap an animal that actuates the trip line, wherein actuation of the trip line places the snare trapping system into a tripped position in which the selective opening is a trigger slot that releases the connection ring and the main line such that the snare loop traps an animal or a portion thereof.

14. The method of claim 13, wherein the selective opening is formed by a slot in a distal end of the base and an arched finger and a recess in a distal end of the pivot arm, wherein in the set position in step (b) the recess of the pivot arm is aligned with a proximal end of the slot in the base and the arched finger of the pivot arm closes a distal end of the slot in the base to form the trigger aperture.

15. The method of claim 14, wherein in the tripped position in step (c) the recess of the pivot arm and the slot of the base form the trigger slot.
